(19) United States
(12) Patent Application Publication
(10) Pub. No.: US 2007/0129103 A1
(43) Pub. Date: Jun. 7, 2007

(54) Cellular phone having multiple lines

(76) Inventor: Saleh A. Al-Shaikh, Houston, TX (US)

Correspondence Address: Galasso & Associates, LP, P.O. Box 26503, Austin, TX, 78755-0503, US

(21) Appl. No.: 11/489,957

(22) Filed: Jul. 20, 2006

Related U.S. Application Data
(60) Provisional application No. 60/742,331, filed on Dec. 5, 2005.

(51) Int. Cl. H04M 1/00

(52) U.S. Cl. 455/551; 455/558

(57) ABSTRACT

Disclosed is a mobile phone which is designed to accept with the phone housing, interface with and register two or more SIM identities on a cellular network. The mobile phone is configurable to have two or more active phone numbers, where for example one number may be a business number and another number may be a personal number. The mobile phone may in certain instances be integrated with or interfaced a handheld electronic device configured to exchange packet data over a cellular network.

### CROSS REFERENCE TO RELATED APPLICATIONS

This application claims priority to co-pending U.S. Provisional Patent Application having Ser. No. 60/742,331 filed Dec. 5, 2005 entitled “DUCELL 2”, having a common applicant herewith.

### FIELD OF THE DISCLOSURE

The disclosures made herein relate generally to mobile phones for use on cellular wireless networks and, more particularly, to cellular phones providing two or more phone lines and phone numbers on a single mobile phone handset.

### BACKGROUND

Mobile phones, also called cellular phones, are in wide use around the world. Mobile phones are quickly gaining on and overtaking conventional land line hardwired telephone equipment in installed numbers. Reasons for this trend include mobility; you can take your phone with you almost anywhere and talk to most anyone else in the world on it at will. Another reason is that versions of today's digital mobile telephones include advanced features that are unavailable on conventional hardwired telephones. Such features include stored contact information, create and edit task to-do lists, keeping track of appointments and reminders, use of a built-in calculator for simple math, ability to send and receive SMS (short text messages), send and receive internet e-mail, perform and participate in instant messaging, browse the internet, play simple games, integrate with other devices such as personal digital assistants (PDAs), and store and play music files. Mobile phones are so personal and portable; most everyone prefers the use of a mobile phone to the use of a conventional hardwired land line phone.

TDMA (time division multiple access) is used as the access technology for Global System for Mobile communications (GSM). GSM systems use encryption to make mobile phone calls more secure. GSM operates in the 900-MHz and 1800-MHz bands in Europe and Asia and in the 850-MHz and 1900-MHz (sometimes referred to as 1.9-GHz) band in the United States. It is used in digital cellular and PCS-based (analog) systems. GSM is the international standard in Europe, Australia and much of Asia and Africa In covered areas, cell-phone users can buy one phone that will work anywhere where the standard is supported. To connect to the specific service providers in these different countries, GSM users simply switch subscriber identification module (SIM) cards. SIM cards are small removable flash memory cards that slip in and out of a socket within GSM cell phones. SIMs store all the connection data and identification numbers you need to access a particular wireless service provider and identifies you as a subscriber to the cell service provider. Your SIM identity is related to one phone number, your cellular number, through a database system at your cellular service provider.

Another type of SIM card that is in use is the W-SIM as manufactured and marketed by Wilcom, Inc. The W-SIM includes the standard CIM functions together with additional core components of a cellular phone including a radio and transmitter built inside.

In newer third generation cellular networks another variety of SIM is available, the wireless broadband (or WiBro SIM). Wireless Broadband, or WiBro, is based on the same standard as WiMAX, 802.16, but WiBro continues to work in motion and is therefore sometimes referred to as mobile WiMAX. WiBro is promoted as bringing mobile broadband access speeds to levels until now seen only on fixed-line networks. WiBro-enabled cellphones and hand held electronic device equipped with WiBro SIMs and cellular network phone controller components allow always-on connections to the Internet, eliminating connection delays and permitting a service similar to that of a broadband fixed-line connection Wireless device which can benefit from the broadband speeds of 3 G networks and WiBro SIMs include digital cellular phones, personal digital assistants (PDAs), and personal digital computers adapted to access the internet over a 3 G WiBro SIM enabled cellular connection.

As can be understood from the above discussion, conventional mobiles phones have one or more drawbacks. One being the ability of a cellular phone to receive a signal varies depending upon the cell phone location. One problem is that not all cellular towers/ networks accept cellular call connections from cell phones subscribed to certain other cellular providers. A cell phone user is apt to encounter this from time to time when ‘roaming’ with the mobile phone, which is to say the user is operating the cellular phone outside the ‘home’ subscription area. As an important side note to the present disclosure, if one had the proper alternate (meaning second) SIM card and cellular subscription, this problem could be oft times overcome.

Another limitation, as discussed earlier, is that a cell phone is ‘locked’ to a single phone number by the SIM card identity of the mobile phone. This limitation forces some people to carry two cellular telephones, one for business use and one for personal use. This is awkward, and as disclosed in this inventive disclosure, now unnecessary.

Therefore, a mobile phone which is designed to accept and register one or more SIM identities, a mobile phone that is configurable to have two or more active phone numbers, where for example one number may be a business number and another number may be a personal number, a mobile phone that accepts two or more SIM cards within the phone housing and is equipped to use all installed SIM cards, a mobile phone that permits the user to select the ‘line’ or phone number to be used when making a call from the available phone numbers registered to the SIMs, a mobile phone that is online and registered with two or more cellular phone numbers at one time, a mobile phone that can access multiple cellular providers at one time thereby overcoming the above discussed limitation of a limited signal when roaming out of the home subscriber area, such a mobile cellular phone would be useful and novel.

### SUMMARY OF THE DISCLOSURE

Accordingly, embodiments of the inventive disclosures made herein comprise various embodiments of a mobile phone or alternatively a hand held electronic device adapted to exchange packet data over a cellular network. The mobile phone or device having inventive features to support two or more ‘lines’, also called phone numbers, wherein each phone number may be registered on a different cellular service provider in certain circumstances. These circumstances include cases where the SIM cards are registered to differing cellular service providers.

In one embodiment of the inventive disclosures made herein, a cellular phone having multiple lines comprises a digital mobile phone controller having a processor. The mobile phone includes a wireless radio transceiver interfaced to the phone controller wherein the transmitter is adapted for communicating with cellular towers of one or more cellular networks. The cellular phone having one or more SIM cards installed into the phone and electrically interfaced to the phone controller. Each SIM having subscriber identity information stored therein. The one or more SIM cards received within the phone housing, wherein each SIM card is electronically interfaced to the phone controller. The subscriber identity of each SIM card is associated with a unique phone number through which the phone initiates, receives calls, wherein the phone has a plurality of phone numbers. The cellular phone further has a means of selecting one of the phone numbers to use for initiating and receiving calls wherein the means of selecting the phone number (also called line herein) is interfaced to the phone controller.

In a second embodiment of the inventive disclosures made herein, a cellular phone having multiple lines as discussed in the first embodiment herein comprises one SIM card wherein the SIM card stores a plurality of subscriber identities, each identity associated with a cellular service provider, wherein each subscriber identity is associated with a unique phone number through which the phone initiates and receives calls such that the phone has multiple phone numbers.

In a third embodiment of the inventive disclosures made herein, a cellular phone having multiple lines as discussed in the first embodiment herein comprises two SIM cards, wherein each SIM card stores a unique subscriber identity and each subscriber identity is associated with a cellular service provider and a phone number through which the phone initiates, receives calls.

In a fourth embodiment of the inventive disclosures made herein, a cellular phone having multiple lines as discussed in the third embodiment herein further comprises two line selection keys operable through a face of the phone. The line selection keys are equipped with a momentary contact switch actuated on key depression. The key contacts are interfaced to the phone controller for initiating a line selection. The line selection keys each keys having a backlight, wherein the backlight illuminates to indicate the line currently in use.

In a fifth embodiment of the inventive disclosures made herein, a cellular phone having multiple lines as discussed in the fourth embodiment is adapted to register on the network with both subscriber identities and respond to incoming calls to either associated phone number, wherein the line select key backlight flashes to indicate the line the call is received upon, wherein the flashing line key is depressed to answer the call.

In a sixth embodiment of the inventive disclosures made herein, a cellular phone having multiple lines as discussed in the second embodiment wherein the means of selecting one of the phone lines comprises two line selection keys operable through a face of the phone. The line selection keys have a momentary contact actuated on key depression with the key contacts interfaced to the phone controller. The line selection keys having a backlight, wherein the appropriate line selection key backlight illuminates to indicate the line currently in use.

In a seventh embodiment of the inventive disclosures made herein, a cellular phone having two lines as discussed in the sixth embodiment is adapted to register on the network with both subscriber identities and respond to incoming calls to either associated phone number. The appropriate line select key backlight flashes to indicate the line the call is received upon, after which the flashing line key is depressed to answer the call.

In an eighth embodiment of the inventive disclosures made herein, a cellular phone having two lines as discussed in the sixth embodiment is a 3 G cellular phone provided with two wireless broadband SIM cards (WiBro SIMs).

In a ninth embodiment of the inventive disclosures made herein, a wireless handheld electronic device is equipped with a cellular phone controller configured to exchange packet data over a cellular phone network. The device comprises a digital mobile phone controller having a processor; a digital wireless radio transceiver interfaced to the phone controller wherein the transmitter is adapted for communicating with cellular towers of one or more cellular networks. The device further comprises two or more wireless broadband WiBro SIM cards each having subscriber identity information stored therein. The two or more WiBro SIM cards received within the device housing. Each WiBro SIM card electronically interfaced to the wireless device phone controller of the device. The subscriber identity of each WiBro SIM card is associated with a unique cellular service provider account through which the wireless device transmits and receives packet data, wherein the phone controller of the wireless device has a plurality of lines and a means of selecting one of the lines to use for initiating cellular network connections and data calls.

In a tenth embodiment of the inventive disclosures made herein, the wireless electronic device is a third generation (3 G) cellular phone.

In an eleventh embodiment of the inventive disclosures made herein, the wireless electronic device is a personal digital assistant (PDA) device adapted to access a cellular network.

In a twelfth embodiment of the inventive disclosures made herein, the wireless electronic device comprises a computer system adapted to access the internet over a cellular network.

In an thirteenth embodiment of the inventive disclosures made herein, a cellular phone has one or more W-SIM cards each having subscriber identity information stored therein, each W-SIM having a cellular transmitter internal to the W-SIM adapted for communicating with cellular towers of one or more cellular networks. The one or more W-SIM cards are received within the phone housing. Each W-SIM card electronically interfaced to the phone controller. The subscriber identity associated with a unique phone number through which the phone initiates, receives calls, wherein the mobile phone has a plurality of phone numbers. The phone is adapted to register on one or more cellular networks with both subscriber identities and respond to incoming calls to either associated phone number, wherein the line select key backlight flashes to indicate the line the call is received upon, wherein the flashing line key is depressed to answer the call.

It is an objective of the inventive disclosure made herein to provide a mobile phone which is designed to accept and register one or more SIM identities.

It is another objective of the inventive disclosure made herein to provide a mobile phone that is configurable to have two or more active phone numbers, where for example one number may be a business number and another number may be a personal number.

It is another objective of the inventive disclosure made herein to provide a mobile phone that accepts two or more SIM cards within the phone housing.

It is another objective of the inventive disclosure made herein to provide a mobile phone that permits the user to select the ‘line’ or phone number to be used when making a call from the available phone numbers registered to the installed SIMs.

It is another objective of the inventive disclosure made herein to provide a mobile phone that is online and registered with two or more cellular phone numbers at one time.

It is another objective of the inventive disclosure made herein to provide a mobile phone that can access multiple cellular providers at one time thereby overcoming the above discussed limitation of a limited signal when roaming out of the home subscriber area in certain circumstances as outlined earlier.

These and other objectives of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one exemplary embodiment of a cellular phone equipped to provide multiple lines in accordance with the inventive disclosures herein.

FIG. 2 depicts a front view of keypad area of the exemplary cellular phone of FIG. 1.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

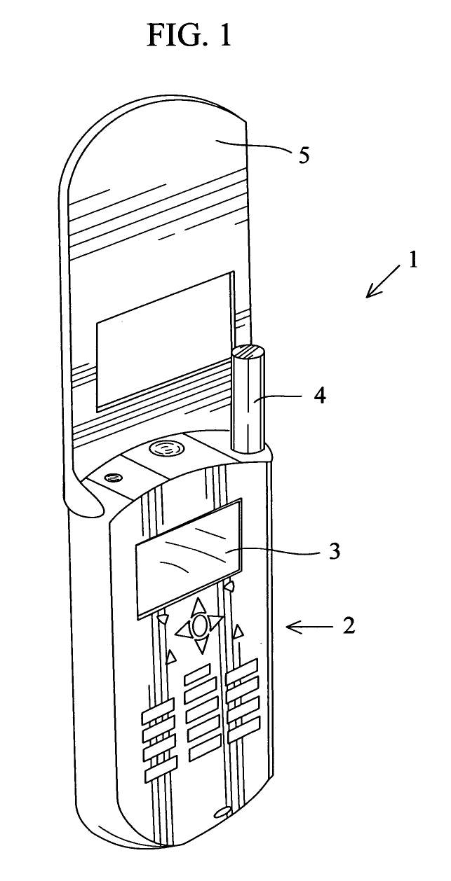

FIG. 1 depicts a perspective view of one exemplary cellular phone equipped with features of the present inventive disclosures. The cellular phone 1 equipped to provide multiple lines has a keypad area 2, a display screen 3 and an antenna 4. The antenna may be retractable into the phone case as illustrated, or may be internal to the cellular phone and therefore not visible. In the illustrated example, the cellular phone is equipped with a hinged cover 5 configured to rotate around a top portion of the cellular phone 1 and cover the keypad area 2 when the phone is not in use. The illustrated phone style is an example only and is not limiting. The multi-line cellular phone of the present invention can be provided in various other typical cell phone styles including flip, rectangular, clamshell, PDA style, or sliding cover types. As with conventional cellular phones, dimensions would vary depending upon the style and features of the phone.

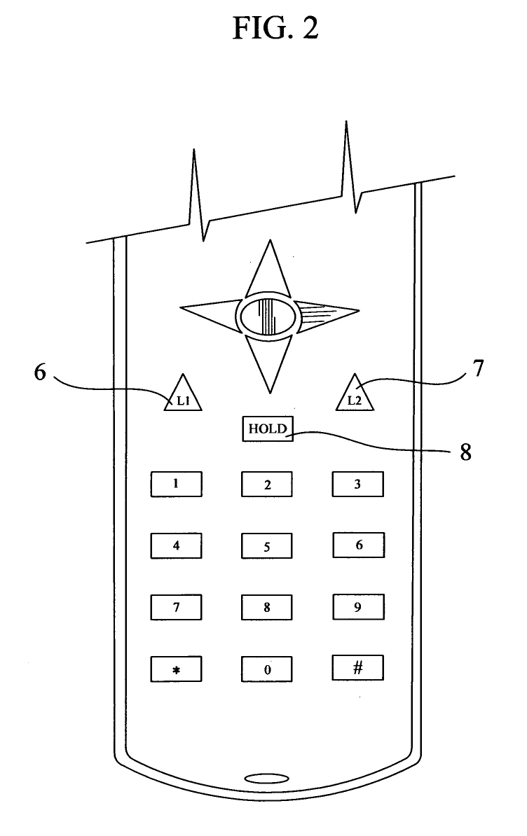

FIG. 2 depicts a front view of keypad area of the exemplary cellular phone of FIG. 1. The keypad area includes a backlit line one select key 6, a backlit line two select key 7, and a call hold key 8. As with typical cellular phones, the cellular phone of the present inventive disclosure would be equipped with a circuit board, antenna 4, a liquid crystal display 3, a numeric keypad, a microphone (hidden in the illustrated example, an audio sound device or loudspeaker (hidden in the illustrated example), two subscriber identity modules installed within the housing of the cellular phone 1, as well as additional keys to implement the line changing features of the present inventive disclosure, namely the “L1” line one select key 6, the “L2” line two select key 7, and the “Hold” key 8. To make an outgoing call, the user would enter the phone number on the keypad in the usual fashion, then depress either the “L1” or “L2” key, depending on the line to be used. When a call is received on a line, either the “L1” or “L2” keys would flash (the backlight of the key flashing) to indicate the line and key to be depressed to receive the call. The “Hold” key functions to place the current call on hold for initiating a second call or receiving another call while the first call remains connected. Cell phones equipped with features of the present inventive disclosure would be capable of the same functions as conventional cell phones, such as a contacts list, as well as typical higher end features on certain phones such as e-mail, internet browsing, games and the like.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, electrical and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A mobile phone having multiple lines comprises:
a digital mobile phone controller having a processor and a phone housing;
a wireless radio transceiver interfaced to the phone controller, the transmitter adapted for communicating with cellular towers of one or more cellular networks;
one or more SIM cards each having subscriber identity information stored therein, the one or more SIM cards received within the phone housing, each SIM card electronically interfaced to the phone controller, the subscriber identity associated with a unique phone number through which the phone initiates, receives calls, wherein the phone has a plurality of phone numbers; and
a means of selecting one of the phone numbers to use for initiating and receiving calls, the means of selecting interfaced to the phone controller, wherein each phone number is alternately referred to as a line.

2. The mobile phone of claim 1, wherein:
the one or more SIM cards is one SIM card, wherein the SIM card stores a plurality of subscriber identities, each identity associated with a cellular service provider, wherein each subscriber identity is associated with a unique phone number through which the phone initiates, receives calls.

3. The mobile phone of claim 1, wherein:
the one or more SIM cards is two SIM cards, wherein each SIM card stores a unique subscriber identity, wherein each subscriber identity is associated with a cellular service provider and a phone number through which the phone initiates, receives calls.

4. The mobile phone of claim 3, wherein the means of selecting one of the phone numbers comprises:
two line selection keys operable on a face of the phone, the keys having a momentary contact actuated on key depression, the key contacts interfaced to the phone controller, the keys having a backlight, wherein the backlight illuminates to indicate the line currently in use.

5. The mobile phone of claim 4, wherein the phone is adapted to register on the network with both subscriber identities and respond to incoming calls to either associated phone number, wherein the line select key backlight flashes to indicate the line the call is received upon, wherein the flashing line key is depressed to answer the call.

6. The mobile phone of claim 2, wherein the plurality of subscriber identities is two subscriber identities; and wherein the means of selecting one of the phone numbers comprises:
two line selection keys operable on a face of the phone, the keys having a momentary contact actuated on key depression, the key contacts interfaced to the phone controller, the keys having a backlight, wherein the backlight illuminates to indicate the line currently in use.

7. The mobile phone of claim 6, wherein the phone is adapted to register on one or more cellular networks with both subscriber identities and respond to incoming calls to either associated phone number, wherein the line select key backlight flashes to indicate the line the call is received upon, wherein the flashing line key is depressed to answer the call.

8. The mobile phone of claim 5, wherein:
the two SIM cards are WiBro SIM cards.

9. A wireless handheld electronic device configured to exchange packet data over a cellular phone network, the device comprising:
a digital mobile phone controller having a processor;
a digital wireless radio transceiver interfaced to the phone controller, the transmitter adapted for communicating with cellular towers of one or more cellular networks;
two or more WiBro SIM cards each having subscriber identity information stored therein, the two or more SIM cards received within the device housing, each WiBro SIM card electronically interfaced to the wireless device phone controller, the subscriber identity associated with a unique cellular service provider account through which the wireless device transmits and receives packet data; wherein the phone controller of the wireless device has a plurality of lines; and
a means of selecting one of the lines to use for initiating cellular network connections, the means of selecting interfaced to the device.

10. The wireless handheld electronic device of claim 9 wherein the device comprise a cellular phone.

11. The wireless handheld electronic device of claim 9 wherein the device comprise a PDA.

12. The wireless handheld electronic device of claim 9 wherein the device comprises a computer system adapted to access the internet over a cellular network.

13. A mobile phone having multiple lines comprises:
a digital mobile phone controller having a processor and a phone housing;
one or more W-SIM cards each having subscriber identity information stored therein, each W-SIM having a transmitter internal to the W-SIM adapted for communicating with cellular towers of one or more cellular networks, the one or more W-SIM cards received within the phone housing, each W-SIM card electronically interfaced to the phone controller, the subscriber identity associated with a unique phone number through which the phone initiates, receives calls, wherein the mobile phone has a plurality of phone numbers; and
a means of selecting one of the phone numbers to use for initiating and receiving calls, the means of selecting interfaced to the phone controller, wherein each phone number is alternately referred to as a line.

14. The mobile phone of claim 13, wherein the phone is adapted to register on one or more cellular networks with both subscriber identities and respond to incoming calls to either associated phone number, wherein the line select key backlight flashes to indicate the line the call is received upon, wherein the flashing line key is depressed to answer the call.

15. The mobile phone of claim 14, wherein the two or more W-SIM cards are active and registered on cellular networks at the same time, and wherein at least one of the W-SIM cards is subscribed to a cellular service provider different from remaining W-SIM cards.
